(19) United States
(12) Patent Application Publication
(10) Pub. No.: US 2025/0158733 A1
(43) Pub. Date: May 15, 2025

(54) TELECOMMUNICATION SYSTEM BASED ON SPATIAL MULTIPLEXING OF OPTICAL CHANNELS

(71) Applicant: PETA OPTIK S. L., San Sebastian (ES)

(72) Inventor: Aquiles PATERNOTTRE ECHEVERRIA, Madrid (ES)

(21) Appl. No.: 18/835,008

(22) PCT Filed: Mar. 29, 2023
(86) PCT No.: PCT/ES2023/070206

§ 371 Date: Jul. 31, 2024

(30) Foreign Application Priority Data
Mar. 30, 2022 (ES) P202230286

(51) Int. Cl. H04J 14/00; H04B 10/11; H04N 7/22

(52) U.S. Cl. CPC H04J 14/05; H04N 7/22; H04B 10/11

(57) ABSTRACT

A telecommunication system is based on spatial multiplexing of optical cables and uses optical space connected modulation (OSCM) to establish optical telecommunication links, where multiple optical communication channels are established with a single optical system. The system comprises: An OSCM transmitter system (1), a communication channel (11), and an OSCM receiver system (2). The OSCM transmitter system (1) includes a data input port (3), an OSCM modulator system (4), a generic light source (8), and an optical transmitter system (10). The OSCM modulator system (4) includes a processor system (5), and a spatial modulator (7). The OSCM receiver system (2) includes an optical receiver system (12), and an OSCM demodulator system (14). The OSCM demodulator system (14) includes an image sensor (13) and a processor system (15). The system allows multiple transmission channels to be formed using a single optical system.

### PURPOSE OF THE INVENTION

The object of the present invention is, as the title of the invention states, a telecommunications system based on spatial multiplexing of optical channels, using Optical Space Connected Modulation (OSCM), to establish wireless optical telecommunications links.

The present invention is characterised by the architecture of the transmitter and receiver systems to obtain a design that allows increased energy efficiency per transmitted bit and higher bit/sec capacities than what can be currently achieved in optical telecommunications links. The modulation in these systems is produced by the pixels of an optical spatial modulator which may be a screen, a projector, a Spatial Light Valve (SLV), a Grating Light Valve (GLV), a set of light sources (each light source would be equivalent to a pixel), or other devices that have pixels in a spatial configuration, in which the symbols that are transmitted in the link are modulated.

The present invention therefore falls within the field of optical telecommunications systems.

### BACKGROUND TO THE INVENTION

In the optical telecommunication links currently in use, the light source that emits the light carrying the information is located at the focus of a transmitting optical system. And the photodetector that receives the light and transforms it into an electrical signal from which the information is extracted is located at the focus of the receiving optical system. As both the light source in the transmitter and the photodetector are located at the focus points, which are single points, and therefore there can only be one light source and one photodetector if there is only one transmitting and receiving optical system.

The capacity of telecommunication systems is given by the Shannon-Hartley formula which indicates that the capacity of the C-channel is:

$$C = B \times {log}_{2} ( 1 + \frac{S}{N} )$$

where:
B is the channel bandwidth in Hertz.
C is the channel capacity (bit rate of information bit(s)).
S is the power of the electrical signal at the receiver after demodulation, which may be expressed in watts, milliwatts, etc., (W, mW, etc.).
N is the noise power added to the electrical signal at the receiver, expressed in the same units as the signal power, S, caused by physical phenomena at the transmitter, channel and receiver.

To increase the capacity of a telecommunications link there are two fundamental ways, increasing B, and multiplexing several channels to send information in parallel. The bandwidth available in the channel, B, depends on the geometry, the material the channel is made of and the clock speed of the electronic circuits. Much progress has been made in improving these factors to obtain higher B values, but the effort required to go further down this route is increasing. Multiplexing a very large number of channels by multiplying the number of systems required by the number of channels is a much less scalable solution than the solution proposed by this invention.

The object of the present invention is to develop a multiple optical channel telecommunications system with multiple transmitters and multiple receivers using common optics for all channels, so that establishing a multiplex of optical channels is more scalable than with current solutions, and which has the characteristics described in the “Disclosure of the Invention” below and essentially set out in the first claim.

A search for possible predecessors has been carried out. The closest that has been found is an article “A Pixelated MIMO Wireless Optical Communication System” in the IEEE Journal of Selected Topics in Quantum Electronics, vol. 12, no. 4, July/August 2026. The fundamental differences with the present invention is that the cited article does not contemplate any optics in the transmitter system which is a key element of OSCM systems, as stated in the first claim.

### DISCLOSURE OF THE INVENTION

The object of the present invention is a telecommunications system based on spatial multiplexing, i.e. in space, of optical channels. The optical modulators/demodulators modulate/demodulate the light of each channel of the multiplex of channels at different points in space which are called pixels. The system comprises a transmitter and a receiver both of the OSCM type by having modulators and demodulators that have pixels.

The information is transmitted by generating an optical image from the spatial modulator of the transmitter onto an array of photodetectors, similar to an image sensor but with fewer and faster pixels, located in the receiver. For this purpose, an optical system similar to a telescope is used with an optical system acting as an objective and there may be another optical system acting as an eyepiece. In the receiver's photodetectors, with the image of the spatial modulator formed on them, the changes produced by the modulation of the light in each of the pixels of the spatial modulator of the transmitter are detected and this allows the information to be extracted.

OSCM links are referred to as “connected” because the radiation emitted by each of the channels present in the link may overlap with that of other channels on its journey from the transmitter to the receiver, forming two-dimensional “connected” surfaces by observing the power distribution of each channel in the cross sections of the propagation of the information, but it is still possible to recover the information. These surfaces are referred to as “OSCM multiplex power surfaces”.

The telecommunications system that is the object of the invention comprises:
An OSCM transmitter system containing:
   A data input port to the OSCM link that receives the bits to be transmitted.
   An OSCM modulator system, which has:
      A processor system, which receives the bits from the controller at the data input port to the link, maps the bits to symbols and generates the electrical signals necessary to produce the appropriate symbol as light passes through the screen.
      The spatial modulator in which the symbols to be transmitted are modulated.
   A generic light source that generates a beam of light which, as it passes through the screen in whose pixels each of the channels is modulated, generates the symbols to be transmitted in the resulting optical signal.
   An optical transmitting system whose function is to maximise the signal power in the OSCM modulated optical channel multiplex to the OSCM receiving system. It may consist of a system with lenses, mirrors, prism systems, diffraction gratings, numerical aperture limiters, diaphragms or diffusers, or combinations thereof.
A communication channel.
An OSCM receiver system containing:
   An optical receiving system whose function is, to create the screen image of the OSCM modulator system on the image sensor of the OSCM demodulator system. It may consist of a system with lenses, mirrors, prism systems, diffraction gratings, numerical aperture limiters, diaphragms or diffusers, or combinations thereof.
   An OSCM demodulator system, which has:
      An image sensor, which receives the optical signal, and extracts the communication symbols into electrical signals that are sent to a processor system.
      A processor system, which receives electrical signals from the image sensor as each of the symbols is received in a time sequence, and de-maps those symbols into bits that are delivered to the controller at the data output port of the OSCM link.

The reason why this OSCM link architecture is proposed is because the capacity of the OSCM channels is:

$$C = B \times ( \frac{S}{N} ) \times {log}_{2} e \frac{bit}{s}$$

Compared to the Shannon-Hartley capacity formula mentioned above in the “Background of the Invention”, the OSCM formula provides clear benefits to the increase in signal power compared to the Shannon-Hartley formula where the signal power is within a logarithm and increases in signal power are not linearly producing capacity increases. This increase in the capacity of communications links is the need that the invention satisfies. With the OSCM technique the power consumption per transmitted bit is optimal.

The OSCM capacity equation linear with (S/N) when the number of channels of the OSCM multiplex, M, meets with M>>(S/N). This is achieved by increasing the number of pixels in the transmitter modulator and the number of photodiodes in the receiver. Achieving a number M>>(S/N) in wireless OSCM links is straightforward because it will consist of increasing the number of pixels in the spatial modulator of the transmitter and the number of photodetectors in the receiver. And form the image of the spatial modulator of the transmitter on the photodetectors of the receiver.

In the state of the art when wireless channels are used for optical transmission of information there must be perfect alignment, a fact that limits their use, however, with the proposed OSCM system perfect alignment is not required, but pointing is sufficient. The alignment required in today's wireless optical telecommunication systems is produced by placing the foci of the transmitting and receiving optical systems and the centres of both optical systems on a single line, which is a very strict condition. The pointing, however, refers to the fact that optical systems have a field of view which is the maximum angle of incidence of the light rays hitting the receiver photodetector array, the larger the field of view the more the receiver can move relative to the emitter without losing the formation of the spatial modulator image on the receiver photodetector array, thus being able to transmit information, the pointing condition is therefore less stringent.

In OSCM links, the radiation from each pixel of the spatial modulator is received on the receiver photodetector array in pixel arrays that are distinct for each transmitting pixel. Establishing a multiplex of OSCM channels.

The maximum number of channels of an OSCM multiplex if there are N pixels transmitting and M receiving, is the minimum value of the pair (M, N).

It is usually desirable to have more pixels in the reception because in imaging, the size of the images cannot be arbitrarily adjusted, it depends on physics, and it is then very difficult to image each pixel of the spatial modulator in a single pixel at the receiver.

Unless indicated otherwise, all the technical and scientific elements used in this specification have the meaning usually understood by a person skilled in the art to which this invention belongs. In the practice of this invention, methods and materials similar or equivalent to those described in the specification may be used.

In the description and claims, the word “comprises”, and its variants do not intend to exclude other technical characteristics, additives, components, or steps. For persons skilled in the art, other purposes, advantages, and characteristics of the invention will be partly inferred from the description and partly from the practical application of the invention.

### EXPLANATION OF THE FIGURES

In order to complement the description being made herein, and with the purpose of aiding a better understanding of the characteristics of the invention, in accordance with a preferred practical embodiment thereof, a set of drawings is accompanied as an integral part of said description, in an illustrative and non-limiting manner, the following has been represented:

FIG. 1 shows a general schematic of the telecommunications system based on spatial multiplexing of optical channels according to the invention.

FIG. 2 shows a schematic of the transmitting and receiving optical systems and the optical signal carrying the information transmitted from the transmitting optical system to the receiving optical system.

### PREFERRED EMBODIMENT OF THE INVENTION

With reference to the figures, a preferred embodiment of the proposed invention is described below.

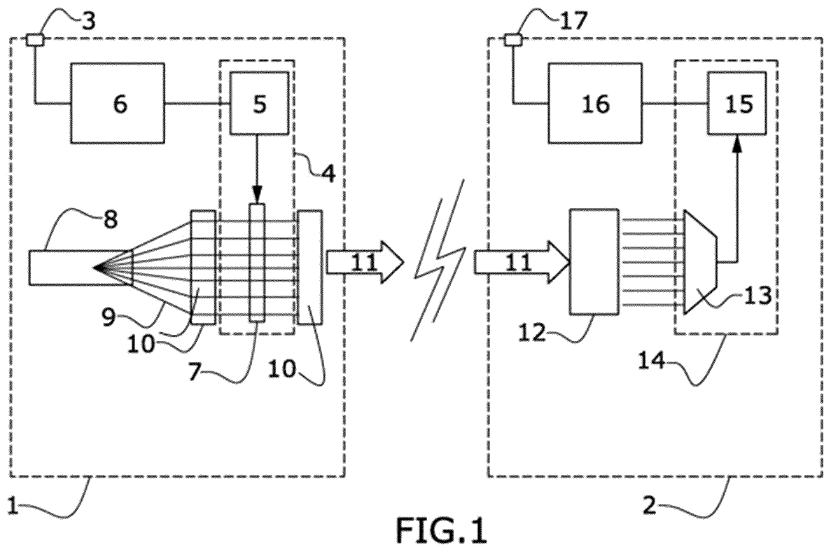

FIG. 1 shows the telecommunications system which is the subject of the invention and which comprises:
An OSCM transmitter system (1) comprising:
   A data input port (3) to the OSCM transmitter system (1), which receives bits to be transmitted.
   An OSCM modulator system (4), comprising:
      A processor system (5), which receives the bits to be transmitted from a controller (6) connected to the data input port (3) to the link, responsible for mapping the bits to symbols and generating electrical signals necessary to produce the appropriate symbol.
      A spatial modulator (7) containing a series of pixels in which the symbols to be transmitted are modulated.
   A generic light source (8) that generates a beam of light (9) which, when passing through the pixels of the spatial modulator (7), will produce a modulation of each of the channels, generating the symbols to be transmitted.
   An optical transmitter system (10) whose function is to maximise the signal power in the multiplex of OSCM modulated optical channels to the OSCM receiver system (2); and, in some cases, to diffract the light before illuminating the screen so that each pixel is illuminated and modulates different wavelengths. It may consist of a system with lenses, mirrors, prism systems, diffraction gratings, numerical aperture limiters, diaphragms or diffusers, or combinations thereof.
A communication channel (11) which may be wireless or waveguided.
An OSCM receiver system (2) containing:
   An optical receiver system (12) whose function is to create an image of the OSCM spatial modulator (7) on an image sensor (13); or, if a diffraction technique has been used in the transmitting optical system, to diffract the received light signal in order to project it onto the image sensor (13) in an orderly manner according to its wavelengths. It may consist of a system with lenses, mirrors, prism systems, diffraction gratings, numerical aperture limiters, diaphragms or diffusers, or combinations thereof.
   An OSCM demodulator system (14), comprising:
      The image sensor (13) that receives the optical signal from the optical receiver system (12) and extracts the communication symbols into electrical signals that are sent to a processor system (15).
      The processor system (15) is designed to receive the electrical signals from the image sensor (13) in a time sequence for each of the symbols, and produces a de-mapping process of those symbols to bits which are delivered to a controller (16) of an output port (17) of the OSCM receiver system (2) data.

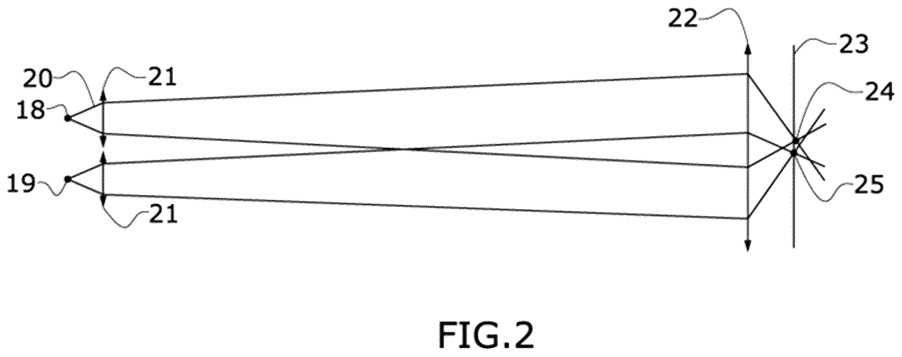

FIG. 2 shows a condenser optic in the transmitting optical system that projects light into the receiving optical system to form an image of the pixels of the transmitting system modulated on a photodetector array, thus making the communication effective. The elements in the figure are:
A pair of pixels modulated with the information signal (18) and (19). There may be more pixels, but only two are shown for clarity of the figure. The pixels are placed closer to the lenses (21) than their focal point so that the beam is not completely collimated and does not travel from transmitter to receiver.
The beams travel from the modulated pixels (18) and (19) experiencing a larger aperture angle at the exit of the source and decreasing in aperture angle as they pass through the lenses (21).
A transmitting optical system consisting of a condensing optical system using convergent optical systems (21), which may consist of one or more components, mirrors, lenses, etc.
A receiving optical system which is a convergent optical system (22), which may consist of one or more components, mirrors, lenses, etc.; and whose function is to form an image of the modulated pixels (18) and (19) on the image sensor (23).
The image of pixel (18) on the image sensor is (24). What is transmitted at (18) is received at (24).
The image of pixel (19) on the image sensor is (25). What is transmitted at (18) is received at (25).

What is claimed is:

1. A telecommunications system based on spatial multiplexing of optical channels, comprising:
an OSCM transmitter system (1) including:
a data input port (3) to the OSCM transmitter system (1), which receives bits to be transmitted.
an OSCM modulator system (4), including:
a processor system (5), which receives the bits to be transmitted from a controller (6) connected to the data input port (3), responsible for mapping the bits to symbols and generating electrical signals necessary to produce an appropriate symbol.
a spatial modulator (7) containing a series of pixels in which the symbols to be transmitted are modulated;
a generic light source (8) that generates a beam of light (9) which, when passing through the pixels of the spatial modulator (7), will produce a modulation of each of the channels, generating the symbols to be transmitted;
an optical transmitter system (10) configured to maximise a signal power in the OSCM modulated optical channel multiplex to the OSCM receiver system (2);
a communication channel (11);
an OSCM receiver system (2) containing:
an optical receiver system (12) configured to create an image of the OSCM spatial modulator (7) on an image sensor (13); or, if a diffraction technique has been used in the transmitting optical system, to diffract a received light signal in order to project the received light signal onto the image sensor (13) according to wavelengths of the received light signal; and
an OSCM demodulator system (14), including:
an image sensor (13) that receives the optical signal from the optical receiver system (12), and extracts the symbols into electrical signals that are sent to a processor system (15); and
wherein the processor system (15) is configured to receive the electrical signals from the image sensor (13) in a time sequence for each of the symbols, and produces a de-mapping process of those symbols to bits which are delivered to a controller (16) of an output port (17) of the OSCM receiver system (2) data.

2. The telecommunications system based on spatial multiplexing of optical channels according to claim 1, wherein the optical transmitter system (10) includes a condenser optical system (14) configured to send a highest signal power to the receiver.

3. The telecommunications system based on spatial multiplexing of optical channels according to claim 1 wherein in that the optical receiver system (12) includes a convergent optical system configured to form images (24) and (25) of the modulated pixels (18) and (19) of the transmitting system onto the image sensor (16) of the receiving system.

4. The telecommunications system based on spatial multiplexing of optical channels according to claim 1, wherein the optical receiver system (12) includes a convergent optical system with optical lens function.

5. The telecommunications system based on spatial multiplexing of optical channels according to claim 1, wherein the optical transmitter system (10) and the optical receiver system (12) each include at least one of: lenses, mirrors, prism systems, diffraction gratings, numerical aperture limiters, diaphragms, diffusers, or a combination thereof.

6. The telecommunications system based on spatial multiplexing of optical channels according to claim 2, wherein the condenser optical system (14) is further configured to send the highest signal power to a boost system for use in wireless links.

7. The telecommunications system based on spatial multiplexing of optical channels according to claim 4, wherein the optical receiver system (12) further includes one or more downstream lenses to magnify or de-magnify the image, for use in wireless optical links.
